(19) United States
(12) Patent Application Publication
(10) Pub. No.: US 2007/0232301 A1
(43) Pub. Date: Oct. 4, 2007

(54) Roaming in wireless networks

(75) Inventor: Victor Y.H. Kueh, Uxbridge (GB)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/730,481

(22) Filed: Apr. 2, 2007

(30) Foreign Application Priority Data
Mar. 31, 2006 (GB) 0606580.9

(51) Int. Cl. H04Q 7/20

(52) U.S. Cl. 455/433

(57) ABSTRACT

The invention relates to a method of roaming for a first UE from a first wireless home network in a visited wireless network comprising the steps of: relocating a session having an established user plane routing which passes through both the first home network and the visited network by supplying information for the first UE from the first home network to the visited network and transferring the user plane away from the first home network.

### FIELD OF THE INVENTION

The present invention relates generally to wireless communications networks, sometimes provided as cellular networks. Such networks can be used for telephony as well as data transfer. The invention has applications in any wireless network including mobile telephone networks operated by any provider of network services operating wirelessly.

### BACKGROUND OF THE INVENTION

Roaming is a term used to describe the use of user equipment (UE) such as a handset or other portable device outside the user's home wireless system. Thus connectivity is provided in a visited network rather than the home network where the UE is registered. The home service area is defined by the extent of the home network and its borders may coincide with geographical borders.

Roaming has always been an important feature and a key revenue generator for mobile wireless networks. With the IP-based 3G mobile networks set to roll-out in the very near future, and with its evolution definition currently underway within the 3GPP standardization, international roaming has been acknowledged as among the key functionalities to be retained in these systems.

This is particularly important because in the near future, more and more services usage is envisaged based on user-to-user communications with the emergence of IP-based applications such as mobile gaming, Push to talk over Cellular (PoC) and video conferencing. On the other hand, recent research [3] has estimated that the number of international mobile roamers (predominantly business travellers or holidaymakers) will more than quadruple between 2004 and 2010, growing from 210 million to 850 million. Given the growing market, and the current problems experienced by roaming users, such as inefficiency with international routing and roaming, it is therefore essential to have solutions to support these roaming users better. It must also be noted that optimal routing for user-to-user traffic in roaming scenarios has been identified as a key requirement/issue for the All-IP Network [4] as well as in 3GPP SAE architecture [5 ].

In UMTS Release 5/6/7 there are two approaches to handle roaming, depending on the choice of location for operator services control. The first approach is a home controlled roaming model and thus allows control of a session (such as a voice call or multimedia session) by the home network. In the first approach, embodied as the GPRS-based roaming model, the IP gateway (corresponding to the GPRS Gateway Support Node (GGSN in 3G)), which all the users' traffic has to traverse, resides in the home network. The second approach is a visited controlled roaming model and thus allows control of a session by the visited network. This second option, embodied as IMS based roaming, utilizes the IP gateway in the visited network to access the user services.

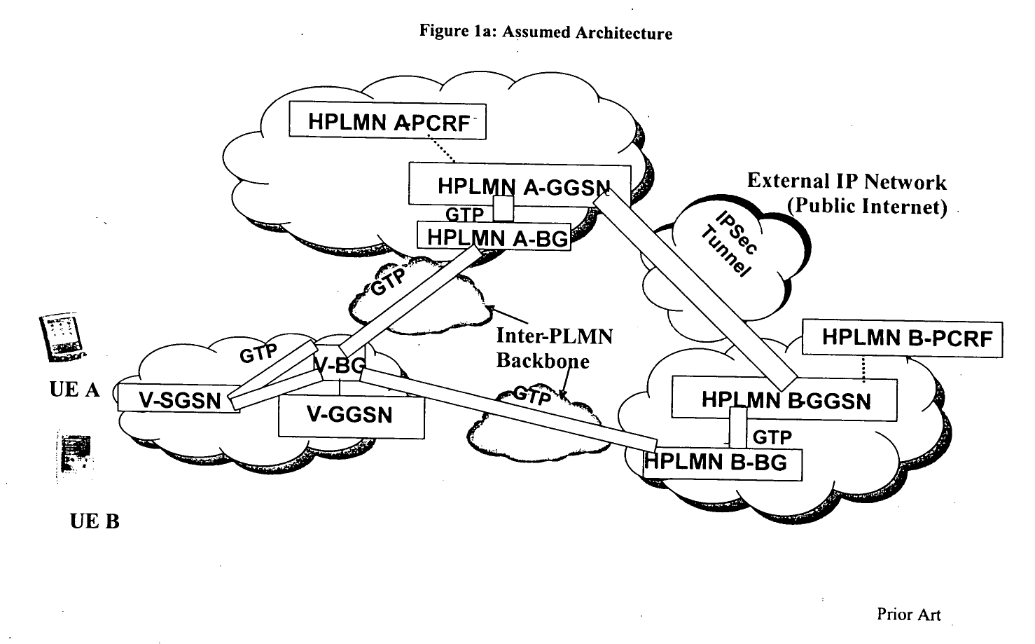

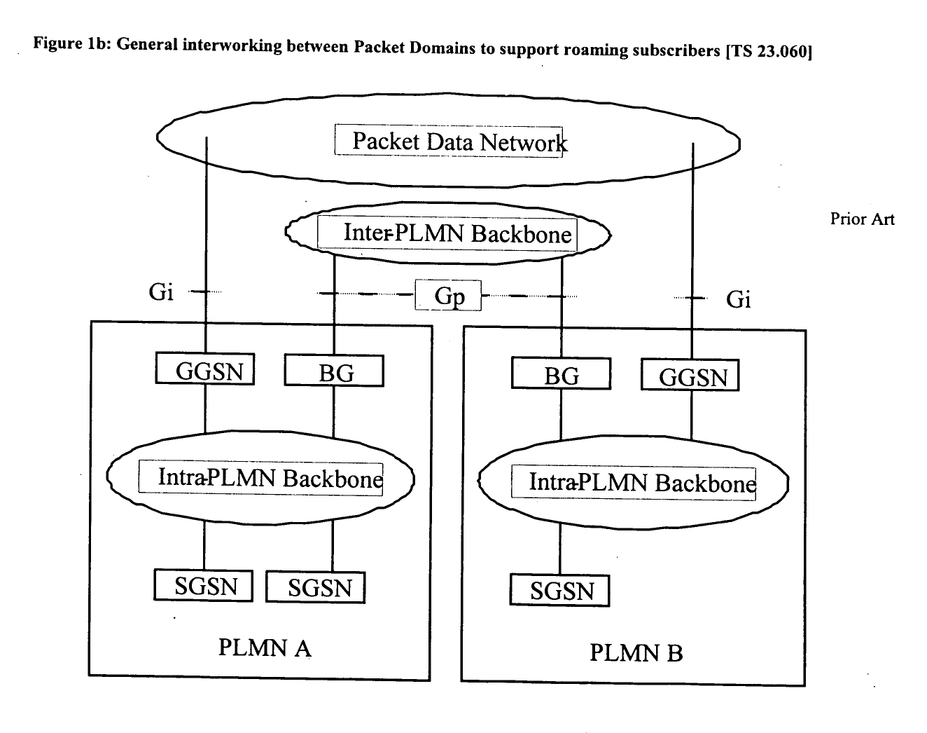

The preferred choice of some existing operators is to utilize the gateway in the HPLMN as a pre-requisite for roaming users since this enables home control of all the user services. Such a system is illustrated in FIG. 1a using the home controlled roaming model.

FIG. 1a shows two roaming users communicating with each other within an assumed architecture for the home controlled roaming model. For simplicity, the radio access network controller (RAN) is not shown. Note that the current notations for network entities in this and the subsequent diagrams follow the existing UMTS R7 (since these are well-known); nevertheless the architecture is applicable for SAE as well, with the replacement of SGSN/GGSN with SAE functional entities, i.e. MME/UPE/lnter AS Anchor.

As can be seen from FIG. 1a, it is assumed that user traffic (that is the “user plane” holding session content rather than signaling, which is in a “control plane”) is carried over GTP tunnels within intra-PLMN, as well as between PLMNs; for the latter, the GTP tunnels traverse a well protected Inter-PLMN backbone (i.e. the network is not open to the public Internet), better known as the GPRS Roaming exchange (GRX). The GTP processing is only performed by GTP-aware entities, i.e. SGSN and GGSN. Communication between PLMNs will need to go through the Border Gateway (BG), located at the edge of each PLMN via the Gp interface—this is in line with [1], the architecture of which is shown in FIG. 1b. With regard to the communication between HPLMN A and B, it is assumed that it will go through the public IP network (e.g. Internet), although it is possible that this portion of traffic can be potentially be carried over GRX as well.

The reason that GTP (across the GRX) is used between VPLMN and HPLMN A, and between VPLMN and HPLMN B, is that it is via the Gp interface. On the other hand, an IPsec tunnel is used between HPLMN A and HPLMN B because no interface is defined between GGSNs in the 3GPP standards, and GTP is only defined for the SGSN and GGSN.

To ensure security of the traffic portion going through the public IP network, it is foreseen that tunnels will be carried by IPsec tunnel—utilizing the tunneling mode option of the IPsec [2]. Note that with the current depiction of FIG. 1a, the IPsec tunnel is established between the GGSNs. In this sense, it is assumed that the GGSN has some functions of the IPsec Gateway, i.e. the IPsec Gateway is collocated with the GGSN. This is not a restriction in implementation, as the IPsec Gateway can likewise be employed as a separate entity from the GGSN. Note also that from here onwards, the BG (border gateway) logical entity has been omitted in all the Figures and discussion for the sake of simplicity. It is foreseen that the BG can potentially be co-located with the GGSN; its exact physical location is implementation-dependent.

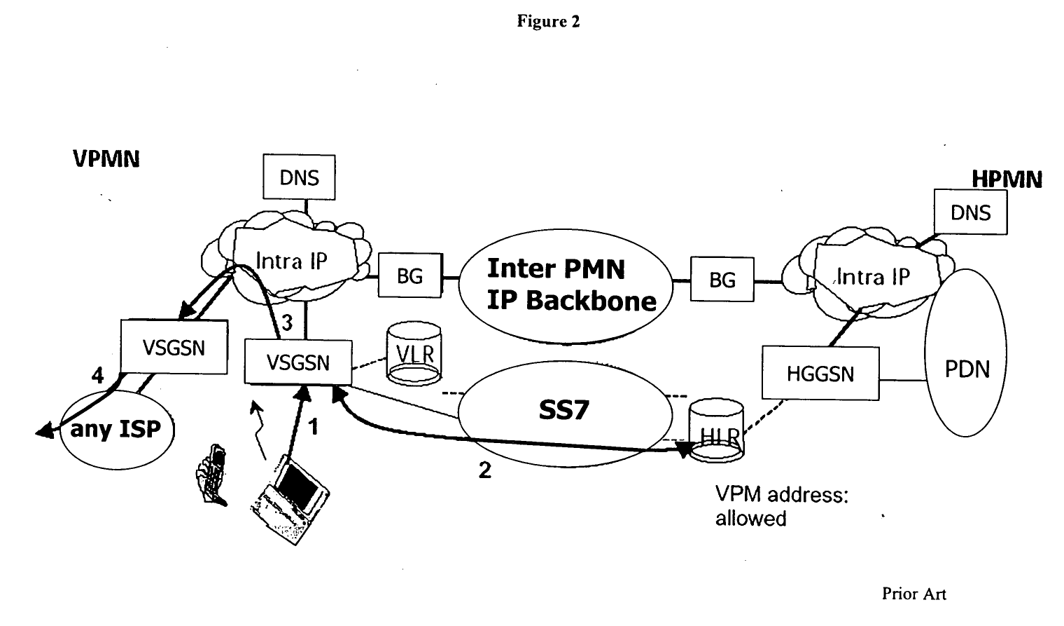

FIG. 2 shows the visited controlled roaming model, embodied as IMS-based roaming in 3GPP. In this model, the IP gateway in the visited network (i.e. the visited GGSN) is utilized to handle the roaming user plane traffic. Since traffic is not forwarded/tunneled to the home domain, it is already routed optimally between the visited domain and the peer node. Also, local breakout is possible with this model since the IP address for the UEs is assigned by the VPLMN.

However, one major disadvantage of this model is that the actual services the roaming users perceive will differ from network to network since the home network does not have direct and full control over the user traffic. Not all the HPLMN services will be available to the roaming users. For example, home non-IMS services such as peer-to-peer (P2P) streaming (e.g. VoD and IPTV applications), business IP-VPN, messaging (e.g. instant messaging, short message service (SMS), multimedia message service (MMS) cannot be provided by the home network.

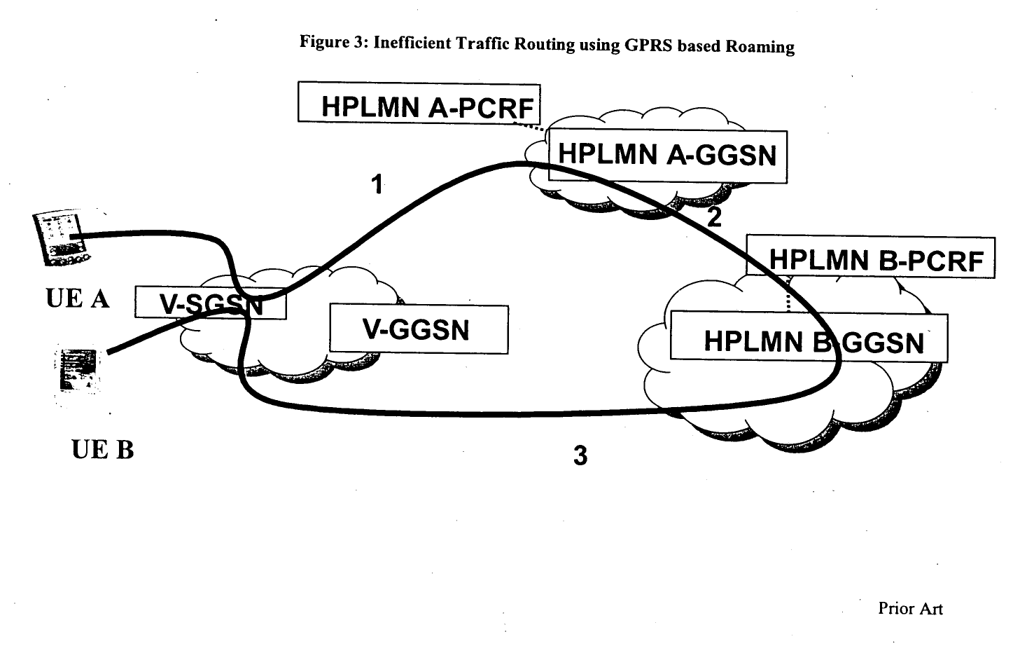

As depicted in FIG. 3, the home control roaming option shown here has a different disadvantage. It suffers from inefficient traffic routing due to the tromboning effect caused by the requirement to take the traffic back to the home GGSN (the traffic needs to go through 3 different call legs). This tromboning not only consumes unnecessary bandwidth over the network backhaul, but also introduces delay to user traffic, which may be unsuitable for the transport of delay sensitive applications, such as real time video/audio services. This inefficiency does not exist with the visited network control-roaming model shown in FIG. 2. Nevertheless, as stated above, the disadvantage with this visited control roaming model is that by using the GGSN in the visited network the HPLMN cannot provide home control and therefore, the services provided will differ from network to network.

It is desirable to overcome the above disadvantages in the known methods of roaming.

### SUMMARY OF THE INVENTION

The invention is defined in the independent claims, to which reference should now be made. Advantageous embodiments are set out in the sub claims.

Thus according to one aspect of the present invention there is provided a method of home-controlled roaming for a first UE from a first wireless home network in a visited wireless network comprising the steps of relocating a session having an established user plane which passes through both the first home network and the visited network by supplying service information for the first UE from the first home network to the visited network and transferring the user plane away from the first home network.

Surprisingly, it has been found that it is possible to combine some of the benefits of both home control and visited control roaming by using home network control and relocating the user plane away from the home network. Supplying information from the home network allows consistent provision of a similar or even the same level of service whether the UE is in its home network or roaming, ideally to provide a so-called “seamless service experience”.

For the first time, it has become feasible to relocate data traffic for an individual session out of the “tromboning” which is typical of home network control.

With a user to user data path transferred away from the first home network, there is a reduction in congestion/overload in the networks. For example in the 3G system, the HPLMN anchor and links are less loaded. Additionally the impact of any possible failure of these parts or links to these paths is reduced. Moreover, the cost of roaming becomes lower and the backhaul load is reduced.

Also, there is a significant reduction in transfer delay for user traffic which enables transport of real-time applications. This benefit is achieved while still allowing the home network to have direct control over traffic from and to the UE. The improved service and increased availability could reduce subscriber churn and user work-around solutions due to increased user satisfaction.

Advantageously, a trigger in the visited network initiates the relocation steps. Thus the user plane relocation is network initiated and the UE is not involved in the signaling.

In preferred embodiments, the control plane remains unchanged during the relocation of the user plane. Thus relocation of the control plane, a critical process in any network, is advantageously avoided and the home network maintains control.

Preferably the method includes a further step of selectively returning to the previously established routing as required. This flexibility in returning to the established routing is facilitated by the fact that the control plane is not relocated. Therefore the optimal transmission path for user data can be switched back to conventional transmission easily without the need to switch the control plane.

A decision not to relocate can also be because some networks (e.g. PLMNs) do not support this proposed functionality. In this case, conventional routing will apply for these networks not supporting this proposed user plane relocation functionality. With this, nodes supporting the method of preferred embodiments can still interwork with nodes that do not support the proposed enhancement, hence ensuring backward compatibility with existing/legacy networks.

Advantageously, the method includes a policy check step before the transfer to check whether relocation is allowed.

The decision to activate user plane relocation may be carried out at a policy node which takes several factors into account, for example user preferences, service requirement, privacy and charging requirements and other operator policies. A policy check, preferably in the home network, and possibly, prior to that, in the visited network allows these factors to be checked and can lead to further relocation steps being discontinued if the relocation is not allowed.

Preferably, the UE IP address in the home network remains unchanged despite the relocation steps. This is an advantage because dynamic IP address allocation at the visited network is not required. Moreover, IP location privacy is achieved because the UE IP address is not used. Hence, the current location of the UE is not disclosed to the other UE or any third party.

Furthermore, there is no need for UE interaction with the present method and signaling over the air is not required for its implementation.

This is in contrast to 3GPP TS 23.060 V6.11.0: “General Packet Radio Service (GPRS); Service description—Stage 2,” December 2005 [1] which requires interaction between the SN and UE for radio access bearer modification.

In preferred embodiments, the relocation steps include a relocation request stage, a policy check stage, a context information transfer stage and a user plane relocation stage. The first three of these relate to information supply and the fourth stage to transfer of the user plane. Such relocation steps may be carried out using signaling between the core network nodes only in the visited and the home networks. Thus there is no signaling to and from the UE involved in relocation.

Preferably, each network includes a serving node, a gateway node and a policy node. These nodes or entities are embodied as the SGSN, GGSN and PCRF in 3G. In the evolved 3GPP network, the equivalents of the SGSN/GGSN are the UPE/MME. The Inter

AS Anchor defined in the evolved 3GPP system may also be involved. In other systems, these nodes (or elements or entities) may well be combined or the functions of a single node may be separated into different entities. For example, the serving node and gateway node may be combined as a single gateway node and signaling between the serving node and gateway node described in the following may be internal to the single gateway node. Nevertheless, the skilled reader will appreciate the equivalent parts in alternative communication systems.

Preferably, the relocation request stage includes a relocation required message from the visited serving node (in the visited network) to the visited gateway node (in the visited network) followed by a request policy/charging rules message from the visited gateway node (in the visited network) to the visited policy node (in the visited network) and then a relocation request from the visited policy node (of the visited network) to the home policy node (of the home network).

Preferably, the policy check is carried out by the policy node in the home network. Preferably an interface is provided between the policy node in the home network and the policy node in the visited network.

Assuming that the relocation request is allowed, the context information transfer stage preferably includes a relocation response from the home policy node to the visited policy node, a context transfer request from the visited policy node to the home policy node, a transfer of context data from the home policy node to the visited policy node and provision of policy data from the visited policy node to the visited gateway node. The policy data may reflect the context data transferred from the home policy node and may additionally or alternatively reflect some aspects of the visited network policy.

Finally, the user plane relocation stage preferably includes a request from the visited gateway node to the home gateway node to relocate user context and a response from the home gateway node to the visited gateway node, followed by a request from the visited gateway node to the visited serving node to update the context and a response from the visited serving node to the visited gateway node.

The session may be between the first UE and a service (or second UE) in the visited network, in which case the transfer stage may transfer the user plane away from the first UE network to entirely within the visited network.

Alternatively when the session is between the first UE and a second UE from a second home network, the established routing may pass through both home networks. Here the method preferably includes relocation away from the second home network of the second UE using relocation steps corresponding to the relocation steps for the first UE. Thus, for example, there is provided a method of improved roaming for a first UE from a first wireless home network and a second UE from a second wireless home network in a visited wireless network comprising the steps of relocating a session having an established user plane which passes through both home networks and the visited network by supplying information for the first UE from the first home network and for the second UE from the second home network to the visited network and transferring the user plane away from one or both home networks. Either home network may not allow the relocation, following a policy check.

Advantageously, a first transfer step or user plane relocation stage transfers the user plane away from the first home network to run through the visited network and the second home network only and a second transfer step transfers the user plane away from the second home network to be entirely within the visited network.

Here the first user plane relocation stage may include transfer of an IPsec tunnel and a GTP tunnel (as shown in FIG. 1). The GTP tunnel is transferred to within the visited network and the IPsec tunnel to between the second home network and visited network (rather than between the two home networks) using the steps set out above.

Transfer of the IPsec tunnel may include a request from the home network gateway node to the second home network gateway node to update the tunnel address, creation of a new IPsec tunnel between the second home network gateway node and visited network gateway node and a response from the second home network gateway node to the first home network gateway node that the tunnel address has been updated. Here, it is assumed that the IPsec gateways are collocated with the network gateway nodes but this is implementation dependent.

The second user plane relocation stage may include the transfer of the GTP tunnel between the second home network and the visited network to within the visited network and removal of the IPsec tunnel between the second home network and visited network. Transfer of the GTP tunnel may follow the steps listed above for the first user plane relocation stage. Where both visiting UEs are from the same home network, the first and second user plane relocation stage both include transfer of a tunnel between the home and visited networks to entirely within the visited network.

The first UE and second UE relocation steps may take place substantially in parallel. Here, the policy node may determine whether relocation of the user plane away from the first and second home networks takes place in parallel by sending the relocation requests to both home networks at the same time or waiting for the relocation to have completed in the first home network before sending the relocation request to the second home network. The user plane relocation stage requires signaling between the home networks to relocate the tunnel between these networks. For example, in the IPsec tunnel transfer detailed above, one home network must request the tunnel address update and the other must respond. Thus there is a possibility of race-condition signaling. Therefore a mechanism may be provided to avoid this; such mechanisms are known in the art.

Preferably, the trigger that starts off the relocation process acts when the first and second UEs are in the same session and within the same visited network, or service area of the visited network.

The present invention also relates to a method in a visited wireless network for improved roaming of a first UE from a first wireless network in the visited wireless network comprising the steps of: relocating a session having an established user plane which passes through both the first home network and the visited network by: receiving information for the first UE from the first home network; and transferring the user plane connection away from the first home network.

Method steps in the visited network correspond to method steps carried out in the visited network as described above for the overall method.

In particular, the relocation request stage includes sending a relocation required message from the visited serving node to the visited gateway node, sending a request policy/charging rules message from the visited gateway node to the visited policy node and sending a relocation request from the visited policy node to the home network.

Preferably the context information transfer stage includes receiving a relocation response from the home policy node at the visited policy node, sending a context transfer request from the visited policy node to the home policy node, receiving a transfer of context data from the home policy node at the visited policy node and providing policy data from the visited policy node to the visited gateway node.

Preferably the user plane relocation stage includes sending a request from the visited gateway node to the home gateway node to relocate user context and receiving a response from the home gateway node at the visited gateway node, followed by sending a request from the visited gateway node to the visited serving node to update the user context and receiving a response from the visited serving node at the visited gateway node.

As before, the session may be between the first UE and a service or second UE of the visited network, in which case the transfer step may transfer the user plane from the first UE home network to entirely within the visited network.

Alternatively, the session may be between the first UE and a second UE from a wireless network other than the visited network. Where the second UE is from a second home network and both UEs are roaming, the established routing may pass through both home networks and the method may include relocation away from the second UE home network using relocation steps corresponding to the relocation steps as defined for the first UE.

The first UE and second UE relocation steps may take place substantially in parallel. The trigger may act when the first and second UEs are in the same session and within the same visited network. In particular, the trigger may act when both UEs are within the same service area in the visited network and belong to the same session.

According to an aspect of the present invention there is also provided a network having means/functionality carrying out the functions previously described for the visited wireless network in use. The network may include a serving node, a gateway node and a policy node.

According to a further aspect of the present invention there is provided a method in a first wireless home network of improved roaming for a first UE from the first wireless home network in a visited wireless network comprising the steps of: relocating a session having an established user plane for the first UE which passes through both the first home network and the visited network by: supplying service information for the first UE to the visited network; and transferring the user plane connection away from the first home network.

Method steps in the home network correspond to the method steps carried out for the home network described above for the overall method.

In particular, the context information transfer stage may include sending a relocation response from the home policy node to the visited policy node, receiving a context transfer request from the visited policy node at the home policy node and transferring context data from the home policy node to the visited policy node.

Preferably the user plane relocation stage includes receiving a request from the visited gateway node at the home gateway node to relocate user context and sending a response from the home gateway node to the visited gateway node.

According to a further aspect of the present invention there is also provided a home network having means/functionality carrying out the relocation steps as defined for the home network in use. The home network may include a serving node, a gateway node and a policy node.

According to a further aspect of the present invention there is provided a trigger in a visited wireless network which triggers a method of improved roaming for a first UE from a first wireless home network and a second UE from a second wireless home network. The trigger is activated when both UEs are within the same service area in the visited network and belong to the same session. The trigger is preferably held in the serving node of the visited network.

According to a further aspect of the present invention there is provided a policy node in a wireless network which has the capability to communicate with a policy node of another wireless network to convey information needed for the relocation of a roaming user plane to transfer context to the other wireless network.

According to a further aspect of the present invention there is provided a gateway node in a wireless network which has the capability to communicate with a gateway node of another wireless network to exchange messages related to relocating context of a roaming user plane.

Preferred features of the present invention will now be described, purely by way of example, with reference to the accompanying drawings, in which:

FIG. 1a is a schematic representation of the user plane in a prior art home control roaming method embodied as GPRS roaming;

FIG. 1b is a schematic illustration of the general interworking between packet domains according to [1];

FIG. 2 is a schematic representation of signal flow in a prior art visited control roaming method embodied as IMS roaming;

FIG. 3 is a schematic representation of the user plane routing using prior art home control roaming;

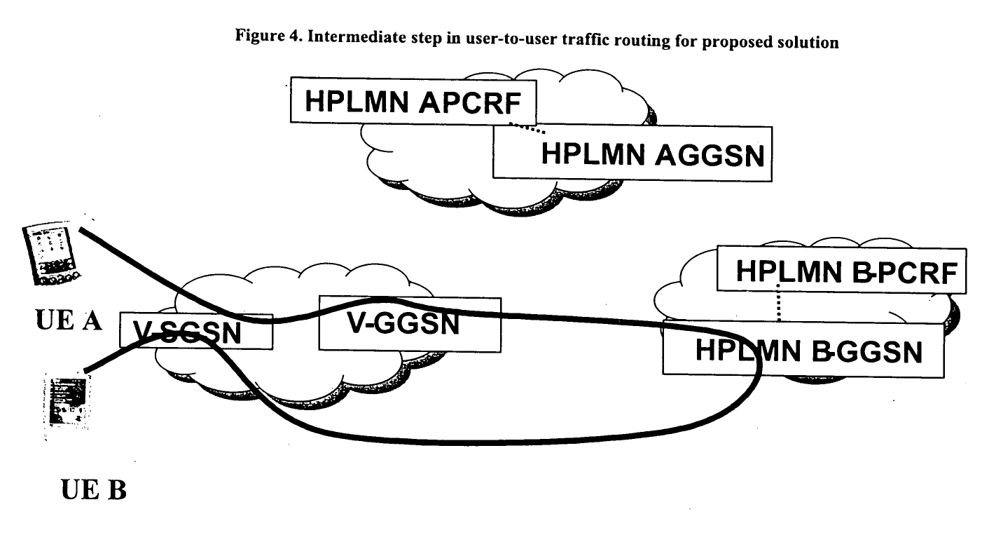

FIG. 4 is a schematic representation of relocation according to an embodiment of the present invention;

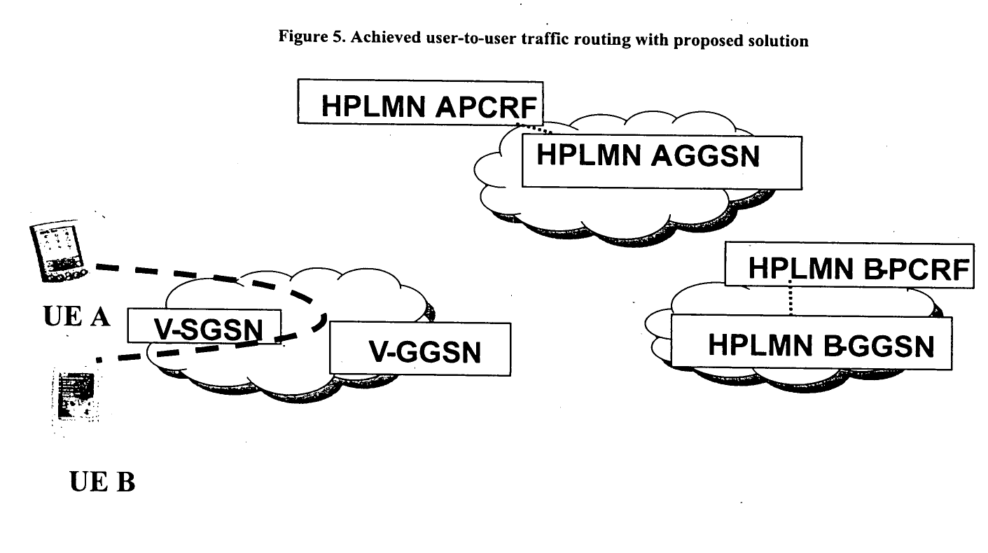

FIG. 5 is a schematic illustration of an optimal relocation according to an embodiment of the present invention;

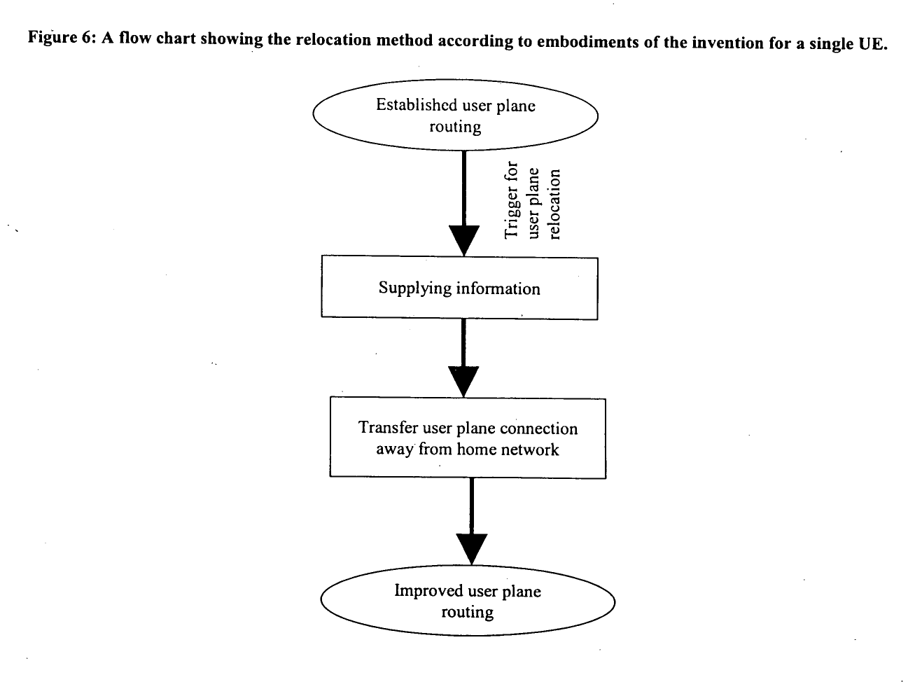

FIG. 6 is a schematic illustration of the method according to embodiments of the invention;

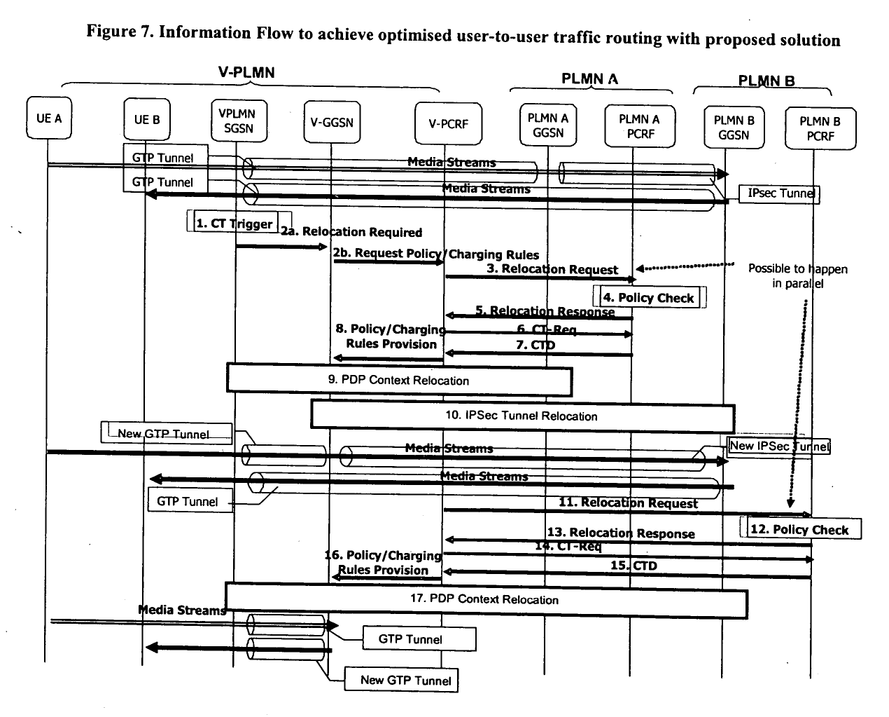

FIG. 7 is a diagram of the information flow to relocate the user plane for two UEs in a preferred embodiment of the present invention;

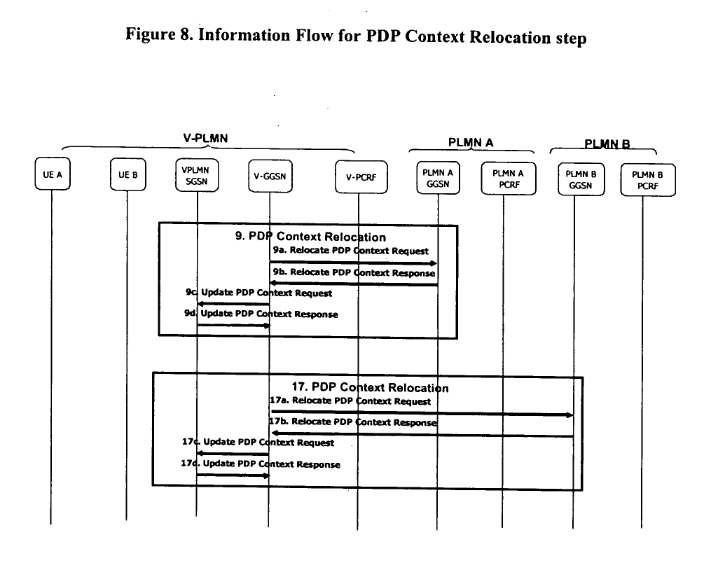

FIG. 8 shows the information flow of steps 9 and 17 of FIG. 7 in more detail for the PDP context relocation; and

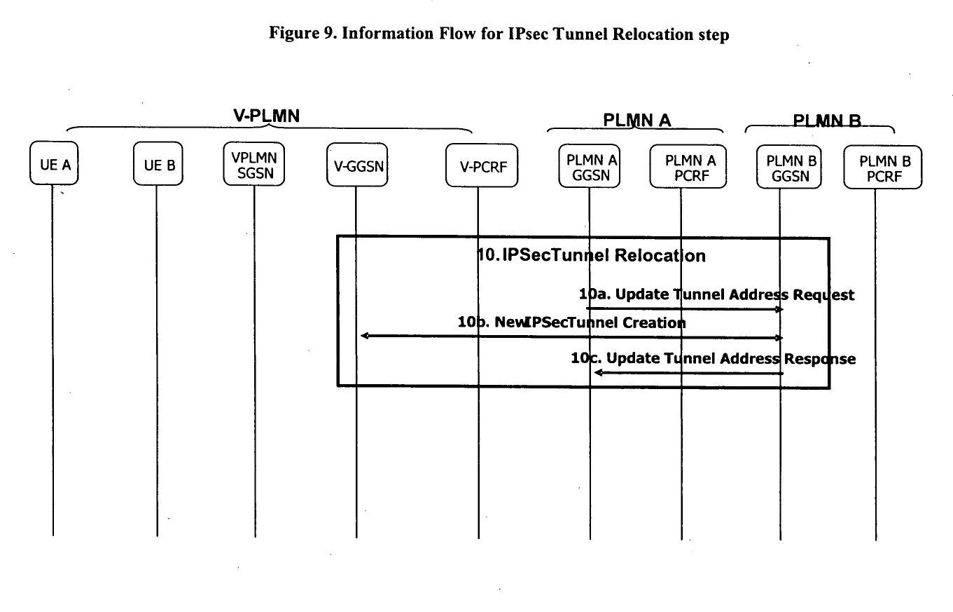

FIG. 9 shows the information flow for the IPsec tunnel relocation step 10 in FIG. 7.

Embodiments of the invention provide a method to enhance the home control (or ‘home routed traffic’) roaming model so as to enable optimised user plane traffic routing. This is achieved through the relocation of the user plane away from the home network and ideally only within the visited network where the roaming users in communication are currently located. FIG. 4 shows routing between UE A and UE B which has been transferred away from the home network A. This may be an intermediate step so that the user plane is subsequently transferred to entirely within the visited network. However, alternatively, the home network for UE B, HPLMN B may refuse to transfer the user plane away from the home network and therefore the routing shown may be the final solution.

An optimised traffic routing allowed by both home networks is shown by FIG. 5, in which case FIG. 4 can be seen to show an intermediate traffic routing (taking FIG. 3 as a starting point).

The diagrams illustrate an embodiment in which both UEs are roaming. However, the skilled reader will appreciate that the invention is also applicable where there is a single roaming UE connected to a local UE or local service in the visited network. In this case, the routing will initially be through the visited network and the home network for that roaming UE (as shown in FIG. 4 if UE A is assumed to be a local UE or local service within the visited network).

FIG. 6 shows the relocation method of embodiments of the invention. Initially there is an established user plane routing which includes routing through the home network.

There is a trigger in the visited network which indicates that user plane relocation could be applicable. This trigger may be, for example, dependent on the visited network recognizing that the user is roaming using a home control roaming method. If the session in question is between two UEs which are both roaming, the trigger may depend on the two UEs being in the same Service Area in the PLMN.

In order for the user plane to be moved away from the home network with no substantial loss of service, service information of the home network may be required. Therefore the next stage is the supply of this information from the home network to the visited network. Subsequently the user plane connection is transferred away from the home network leading to an improved user plane routing while maintaining the control plane in the home network.

Where there are two roaming UEs involved in this method, the user plane passes through both home networks. Supplying service information for the first UE allows the user plane to be transferred away from the home network for that UE with no loss of service. In this case the user plane will now run between the first UE in the visited network, across to and back from the second home network and back through the visited network to the second UE. In a further transfer step, the user plane is transferred away from the second home network to be entirely within the visited network.

In each case, for the transfer step, a “dog-leg” of two tunnels between networks is removed. If the routing is already to one home network only (e.g. only one of the users is roaming or the user plane has already been transferred away from one home network) the transfer away from the home network leads to the user plane being routed entirely within the visited network.

One common situation is that two UEs from the same home network are roaming within a single visited network. Here, each UE will have a separate relocation request to relocate the tunnel from its home network to within the visited network.

To ensure consistent provision of user service experience (seamless service experience), service information such as the related QoS attributes and policy information as well as the charging information is transferred from the home network to the visited network, for example from each of the respective network elements or nodes in HPLMN to the network element in VPLMN in a 3G system. This information will then be subsequently conveyed to the gateway in VPLMN so that it can execute the right resource allocation and rating, in accordance with the previously defined configuration by the HPLMNs.

A detailed procedure for the proposed solution to achieve optimised user-to-user traffic routing in GPRS can be explained by the embodiment shown in FIG. 7. As noted above, the method is suitable for implementation using different technologies.

The user traffic (or plane) is currently not routed optimally between user A and B although they are located in the same PLMN (refer to FIG. 3 for the routing) (note for the current depiction, it is assumed that both user A and B are served by the same SGSN in VPLMN).

The relocation method has the following steps:
1. The relocation of the user data, path is initiated by a trigger in the network. With two visiting UEs, this is achieved when the network (SGSN) identifies that both users are:
i. within the same Service Area in the PLMN; and
ii. belong to the same session
   To determine that the UEs are within the same Service Area in the PLMN, the Tunnel Endpoint Identifier (TEID) [6] can possibly be used; while the session ID is used to identify that both UEs are in the same communicating session; one example of such ID which can be used is the Transaction Identifier [7]. Note that UE IP address cannot be utilised in the existing GPRS system, which does not use UE IP address for packet routing. Even if it is used, UE IP address will not be of much help since it is assigned by HPLMN.
2. V-SGSN sends a Relocation Required message to the V-GGSN to start the relocation process. Identities pertaining to the UEs are included (e.g. IMSI/MSISDN). When the V-GGSN determines that the PCC authorization is required, it requests the subscriber's authorization, allowed service(s) and Policy and Charging Rules information from the proxy PCRF in VPLMN. Before step 3, the V-PCRF may also check whether the visited network is set to anchor user traffic locally.
3. The PCRF in the VPLMN forwards the Relocation Request message to the home network to check if local breakout of traffic is possible within the VPLMN of the associated UEs in session. With this, identities pertaining to the UEs are included (e.g. IMSI/MSISDN)
4. The home PCRF checks whether its UE is allowed to have traffic to be broken out locally in the VPLMN. In making this decision, it checks with its local (operator) policy, which among others include privacy and charging requirements, and service requirements (obtained from the Application Function (AF). In addition, the home PCRF may consult the HSS and/or the Subscription Profile Repository (SPR) which contains all subscriber/subscription related information, for e.g. user preferences. (Note: The HSS and SPR are not shown in FIG. 7 for simplicity. The correlation/relation of SPR with the HSS is yet to be defined within 3GPP).
5. The home PCRF sends a Relocation response to the visited/proxy PCRF in the VPLMN to inform its decision of the relocation request (it is assumed herein that this request is allowed by the respective HPLMN).
6. Upon confirmation that the relocation of traffic request to the VPLMN is possible, the V-PCRF sends a request to the home PCRF for the necessary information required for traffic control in the VPLMN. This context request can potentially use the Context Transfer Request (CT-Req) message defined in [8].
7. Home PCRF transfers the required information, which potentially may include rule identifier, service data flow filters (for service data flow detection), and its precedence, service identifier, charging key, charging method, measurement method, reporting method/level, QoS settings/limits (e.g. QoS class/priority, bit rate) for the set of IP flow(s) and restrictions on the individual IP flow(s) for the session between UE A and B. The information transferred is implementation dependent. This context information transfer can potentially use the Context Transfer Data (CTD) message defined in [8].
8. Based on the received information from the home PCRF, the V-PCRF sends the policy and charging rules to the V-GGSN, which will enforce the decision. Note that the decision could also be potentially based on the policy and charging rules in the roaming network (VPLMN) if the VPLMN decides to enforce its own policy and charging rules, which may be different from the ones in HPLMN.
9. Upon receiving the Bearer Authorization Response from the V-PCRF, the V-GGSN sends a Relocate PDP Context Request message to the GGSN in PLMN A to initiate the PDP context (tunnel) relocation from GGSN in PLMN A to GGSN in VPLMN (FIG. 8). This request will contain the credentials to inform the HPLMN A GGSN that the V-GGSN has the permission from the home network to ‘anchor’ the UE A traffic for this session. Only the user plane relocation (GTP-U tunnel) takes place—the control plane connection (GTP-C tunnel) remains unchanged (i.e. GTP-C tunnel is not moved). PLMN A GGSN sends a response to acknowledge this relocation. The V-GGSN then sends an Update PDP Context Request message to the V-SGSN as per [1]. The V-SGSN acknowledges this by sending the Update PDP Context Response message. Note that compared to [1], the necessary interaction between the SGSN and UE (for the radio access bearer modification) is not required since existing radio access bearer between SGSN to UE can be reused. There is no need for UE interaction and hence, signaling over the air is not required.
10. Given that PLMN GGSN A already knows that the user data path (GTP tunnel) needs to be relocated to VPLMN (it has received the Relocate PDP Context Request message from V-GGSN), it sends an Update Tunnel Address Request message to PLMN B GGSN to inform PLMN B GGSN of the new endpoint of the IPsec tunnel that needs to be established for the IPsec tunnel relocation (from PLMN B-PLMN A to PLMN B-VPLMN). With the current depiction of the assumed architecture (FIG. 1), it is assumed IPsec Gateway is collocated with GGSN. PLMN B GGSN then initiate message exchange with the V-GGSN for the IPsec tunnel creation (tunnel mode) as per [2]. Upon successful creation of this new tunnel between PLMN B GGSN and V-GGSN, PLMN B GGSN sends an Update Tunnel Address Response to inform PLMN A GGSN that the IPsec tunnel relocation is successful. This acknowledgement could also prompt PLMN GGSN A to tear down the old tunnel between PLMN A with PLMN B by deleting their security association (SA), if it is no longer used.
   Upon successful PDP context relocation (step 9) and IPsec tunnel relocation (step 10), the user plane traffic for UE A is now localised within VPLMN (FIG. 7).
11.-16. These steps concerning UE B are similar to steps 3-8 (explained above for UE A). Note that steps 11-16 can possibly happen before steps 3-8 or they can happen in parallel.
   In both cases, V-PCRF will initiate the signaling once it receives the Request Policy/Charging Rules message from V-GGSN. Note that it is possible that the relocation request may be rejected by each of the UE's HPLMN due to each own PLMN policy. If either PLMN does not approve the relocation of the user plane, the invention still works albeit only sub-optimum routing is achieved—e.g. if PLMN B does not allow the relocation of its traffic to VPLMN, this does not interfere with the optimised routing for the UE A traffic portion (FIG. 3).
   When steps 11 to 16 occur in parallel to steps 3 to 8, there is always a possibility that a race-condition signaling will occur with respect to the IPsec tunnel relocation. There are mechanisms which can avoid this, the exact details of which are beyond the scope of this invention. If no mechanism is in place then, assuming the best case, there will not be any IPsec tunnel relocation, and in the worse case, there will be two IPsec tunnels created (i.e. between PLMN B with VPLMN and between PLMN A and VPLMN). In all cases, no impact to the routing of the UE A-UE B traffic is foreseen, as the traffic would have been routed optimally entirely within the VPLMN by then.
17. This step is similar to step 9 with the PDP context (GTP-U tunnel) being relocated from PLMN B GGSN to V-GGSN
   With the UE A-to-UE B traffic now localised within the VPLMN, the IPsec tunnel between the PLMN B and VPLMN (established in step 10) can be torn down, if it is no longer used.

If both UEs are from the same home network, the V-PCRF still sends two relocation requests. The difference in the method is that there is no IPsec tunnel relocation, so only PDP context relocation is required and step 10 is omitted. The method may, however, include creation of an IPsec tunnel as explained in the following:

It is assumed UE A and UE B are from network B with the user plane shown in FIG. 4. UE A relocates first. The GTP tunnel from V-SGSN to HPLMN B-GGSN becomes a GTP tunnel within the visited network, but we need to create a tunnel between the visited network and HPLMN B (to maintain the connection with UE A).

Hence there is no advantage in user plane re-routing of a single user, as effectively the GTP tunnel across PLMNs is replaced with an IP tunnel (in this case an IPsec tunnel for security reasons).

However, the optimal routing is achieved as before when both roaming UEs are relocating; if these relocations happen in parallel, then there is no need for creation of an IPsec tunnel.

An important part of the invention embodiments is the triggering mechanism that initiates the relocation of the data path (step 1). Based on the proposed method, the criteria to trigger the path relocation are simple to implement, and do not require additional signaling or external measurement, but are based on readily available/existing identifications in 3G network. Furthermore, since the user plane relocation trigger is network-initiated, any possible ‘malicious attacks’ by third party by sending ‘false’ relocation is minimized. Also, the proposed mechanism does not need UE interaction, and hence signaling over the precious and security-susceptible radio interface is avoided.

The invention embodiments introduce new capabilities to the network entities, i.e. the SGSN, GGSN and PCRF, as well as new interfaces in the core network between the two PCRFs and the two GGSNs (policy nodes and gateway nodes). Thus, a new interface between the visited PCRF in the VPLMN and the home PCRF is introduced. Via this interface, 4 new messages are exchanged between the PCRFs (appearing in steps 3, 5, 6, 7, 11, 13, 14, 15). As mentioned previously, the CT-Req and CTD messages can potentially be based on the ones defined in the IETF [8].

In step 2a, the Relocation Required is a new message introduced in the SGSN—it is similar to the existing request for bearer establishment (e.g. Create PDP Context Request/Update PDP Context Request), but instead specific for bearer relocation purposes.

Steps 9a and 9b (likewise, steps 17a and 17b) introduce new functionality to the GGSN with signaling exchanges between the GGSNs over GTP-C (for the PDP Context relocation). Note that with the existing standards, signaling exchange between GGSNs does not exist. As for the Update PDP Context Request and Update PDP Context Response, it is envisaged that the messages defined in [1] can be used. The PDP context relocation (steps 9 and 17) does not require V-PLMN to assign a new IP address to either UE A or B with both UEs still use their existing IP address. With this, the current location of UEs are not disclosed to each other (or to external parties), and hence IP location privacy, which is becoming a more and more important requirement in next generation mobile network, is maintained.

The messages involved for IPsec tunnel relocation (step 10) are also new with the invention embodiments—this will be extra feature to the GGSN, if the IPsec Gateway is assumed to be collocated with the GGSN.

Embodiments of the present invention may be implemented in hardware, or as software modules running on one or more processors, or on a combination thereof. That is, those skilled in the art will appreciate that a microprocessor or digital signal processor (DSP) may be used in practice to implement some or all of the functionality of the wireless network entities embodying the present invention. The invention may also be embodied as one or more device or apparatus programs (e.g. computer programs and computer program products or a suite of one or more computer programs) for carrying out part or all of any of the methods described herein. Such programs embodying the present invention may be stored on solid computer-readable media, or could, for example, be in the form of one or more signals. Such signals may be data signals downloadable from an Internet website, or provided on a medium such as a computer-readable carrier signal, or in any other form.

References (All of these documents are incorporated by reference)

[1] 3GPP TS 23.060 V6.11.0: “General Packet Radio Service (GPRS); Service description—Stage 2,” December 2005
[2] S. Kent and K. Seo, “Security Architecture for the Internet Protocol,” Request for Comments 4301, IETF, December 2005
[3] http://www.informatm.com/marlin/20001001561/INDEX
[4] 3GPP TS 22.258 V7.0.0: “Service Requirements for the AII-IP Network (AIPN)—Stage 1, ”December 2005
[5] 3GPP TR 23.882 V0.b.0: “3GPP System Architecture Evolution: Report on Technical Options and Conclusions,” February 2006
[6] 3GPP TS 29.060 V7.0.0: “GPRS Tunneling Protocol (GTP) across the Gn and Gp interface (Release 7),” December 2005
[7] 3GPP TS 24.007 V7.0.0: “Mobile radio interface signaling layer 3; General aspects (Release 7),” September 2005

[8] J. Loughney (Ed.), M. Nakhjiri, C. Perkins and R. Koodli, “Context Transfer Protocol (CXTP),” Request for Comments 4067, IETF, July 2005

Acronyms

| | |
|---|---|
| 3GPP | 3^{rd} Generation Partnership Project |
| AF | Application Function |
| AP | Access Point |
| BG | Border Gateway |
| CTD | Context Transfer Data |
| CT-Req | Context Transfer Request |
| GGSN | GPRS Gateway Support Node |
| GPRS | General Packet Radio Service |
| GTP | GPRS Tunnelling Protocol |
| HLR | Home Location Register |
| HPLMN | Home Public Land Mobile Network |
| HSS | Home Subscriber Server |
| IMSI | International Mobile Subscriber Identity |
| Inter AS Anchor | Inter Access Anchor |
| MME | Mobility Management Entity |
| MSISDN | Mobile Subscriber ISDN Number |
| PCRF | Policy Charging Rules Function |
| PDP | Packet Data Protocol |
| PLMN | Public Land Mobile Network |
| PoC | Push to Talk over Cellular |
| QoS | Quality of Service |
| RAN | Radio Access Network |
| RNC | Radio Network Controller |
| RNS | Radio Network Subsystem |
| SAE | 3GPP System Architecture Evolution |
| SGSN | Serving GPRS Support Node |
| SMS | Short Message Service |
| SN | Signalling Node |
| SPR | Subscription Profile Repository |
| SS7 | Signalling System 7 - high speed signalling protocol |
| | for land line |
| TAP | Billing protocol developed by GSM assoc. |
| | CSM/GMTS |
| TEID | Tunnel Endpoint Identifier |
| UE | User Equipment |
| UMTS | Universal Mobile Telecommunications System |
| UPE | User Plane Entity |
| VLR | Visitors Location Register |
| VPLMN | Visited Public Land Mobile Network |
| V-SGSN | Visited Serving GPRS Support Node |

1. A method of roaming for a first UE from a first wireless home network in a visited wireless network comprising the steps of: relocating a session having an established user plane routing which passes through both the first home network and the visited network by supplying information for the first UE from the first home network to the visited network and transferring the user plane away from the first home network.

2. A method according to claim 1 wherein a trigger in the visited network initiates the relocation steps.

3. A method according to claim 1 wherein the control plane remains unchanged during relocation of the user plane.

4. A method according to claim 1 further including a step of selectively returning to the previous established routing as required.

5. A method according to claim 1 including a policy check step before the transfer to check whether relocation is allowed.

6. A method according to claim 5 wherein the policy check is carried out in the first home network.

7. A method according to claim 6 wherein an initial policy check is carried out by the visited network.

8. A method according to claim 1 wherein the UE IP address in the home network remains unchanged despite the relocation steps.

9. A method according to claim 1 wherein the relocation steps include a relocation request stage, a policy check stage, a context information transfer stage, and a user plane relocation stage.

10. A method according to claim 1 wherein the relocation steps are carried out using signaling between core network nodes only in the visited and home networks and wherein each network includes a serving node, a gateway node and a policy node.

11. A method according to claim 10 wherein the relocation request stage includes a relocation required message from the visited serving node to the visited gateway node followed by a request policy/charging rules message from the visited gateway node to the visited policy node and then a relocation request from the visited policy node to the home policy node.

12. A method according to claim 10 wherein the policy check stage is carried out by the home policy node.

13. A method according to claim 10 wherein the context information transfer stage includes a relocation response from the home policy node to the visited policy node, a context transfer request from the visited policy node to the home policy node, a transfer of context data from the home policy node to the visited policy node and provision of policy data from the visited policy node to the visited gateway node.

14. A method according to claim 10 wherein the user plane relocation stage includes a relocate user context request from the visited gateway node to the home gateway node and a response from the home gateway node to the visited gateway node, followed by an update user context request from the visited gateway node to the visited serving node and a response from the visited serving node to the visited gateway node.

15. A method according to claim 1 wherein the session is between the first UE and a service or second UE of the visited network and wherein the transfer step transfers the user plane connection away from the first UE home network to entirely within the visited network.

16. A method according to claim 1 wherein the session is between the first UE and a second UE from the same home network and the transfer step includes transferring the user plane away from the home network to entirely within the visited network.

17. A method according to claim 1 wherein the session is between the first UE and a second UE is from a second home network and both UEs are roaming.

18. A method according to claim 17 wherein the established routing passes through both home networks and the method includes relocation away from the second home network of the second UE.

19. A method according to claim 17 wherein a first transfer step transfers the user plane connection away from the first home network to run through the visited network and the second home network only and a corresponding second transfer step transfers the user plane connection away from the second home network to be entirely within the visited network.

20. A method according to claim 10 wherein the user plane relocation stage includes a relocate user context request from the visited gateway node to the home gateway node and a response from the home gateway node to the visited gateway node, followed by an update user context request from the visited gateway node to the visited serving node and a response from the visited serving node to the visited gateway node;
wherein a first transfer step transfers the user plane connection away from the first home network to run through the visited network and the second home network only and a corresponding second transfer step transfers the user plane connection away from the second home network to be entirely within the visited network; and
wherein the user plane relocation stage further includes a request from the home network gateway node to the second home network gateway node to update a tunnel address, creation of a new tunnel between the second home network gateway node and visited network gateway node and a response from the second home network gateway node to the first home network gateway node that the tunnel address has been updated.

21. A method according to claim 16 wherein the first UE and the second UE relocation steps take place substantially in parallel.

22. A method according to claim 1 wherein a trigger in the visited network initiates the relocation steps;
wherein the session is between the first UE and a second UE from the same home network and the transfer step includes transferring the user plane away from the home network to entirely within the visited network; and
wherein the trigger acts when the first and second UEs are in the same session and within the same visited network.

23. A method in a visited wireless network for roaming of a first UE from a first wireless network in the visited wireless network comprising the steps of:
relocating a session having an established user plane which passes through both the first home network and the visited network by:
receiving information for the first UE from the first home network; and
transferring the user plane connection away from the first home network.

24. A visited wireless network allowing roaming of a first UE from a first wireless network in the visited wireless network comprising:
visited network nodes operable to relocate a session having an established user plane which passes through both the first home network and the visited network including;
a visited network gateway node operable to receive information for the first UE from the first home network; and
a visited network signaling node operable to transfer the user plane connection away from the first home network.

25. A method in a first wireless home network of roaming for a first UE from the first wireless home network in a visited wireless network comprising the steps of:
relocating a session having an established user plane routing for the first UE which passes through both the first home network and the visited network by supplying information for the first UE to the visited network; and
transferring the user plane connection away from the first home network.

26. A first wireless home network allowing roaming for a first UE from the first wireless home network in a visited wireless network comprising: home network nodes operable to relocate a session having an established user plane routing for the first UE which passes through both the first home network and the visited network; including
a home network policy node operable to supply information for the first UE to the visited network;
and a home network gateway node operable to transfer the user plane connection away from the first home network.

27. A signaling node in a visited wireless network which comprises a processor operable to trigger a method of improved roaming for a first UE from a first wireless home network and a second UE from the first or a second wireless home network, wherein the trigger is activated when both UEs are within the same service area in the visited network and belong to the same session.

28. A policy node in a wireless network which has the capability to communicate with a policy node of another wireless network to convey information needed for the relocation of a roaming user plane to transfer context to the other wireless network.

29. A gateway node in a wireless network which has the capability to communicate with a gateway node of another wireless network to exchange messages related to relocating context of a roaming user plane.

30. A computer readable medium storing a suite of computer programs which, when executed on computing devices in a home wireless network and a visited wireless network, causes the networks to carry out the method as defined in claim 1.

31. A computer readable medium storing a suite of computer programs which, when executed on computing devices in a visited wireless network, causes the network to carry out the method as defined in claim 23.

32. A computer readable medium storing a suite of computer programs which, when executed on computing devices in a home wireless network, causes the network to carry out the method as defined in claim 26.

33. A computer readable medium storing a suite of computer programs which, when loaded onto computing devices in a wireless network causes the computing devices to together become a wireless network as defined in claim 25.

34. A computer readable medium storing a suite of computer programs which, when loaded onto a computing device in a node of a wireless network causes the node to become a policy node as defined in claim 30.

35. A computer readable medium storing a suite of computer programs which, when loaded onto a computing device in a node of a wireless network causes the node to become a gateway node as defined in claim 31.
